(19) United States
(12) Patent Application Publication
(10) Pub. No.: US 2026/0370323 A1
(43) Pub. Date: Nov. 19, 2026

(54) APPARATUSES AND METHODS FOR FACILITATING A DYNAMIC RADIO ACCESS NETWORK WITH RETRIEVAL-AUGMENTED GENERATION FOR SATELLITE GEO-LOCATION

(71) Applicant: AT&T Intellectual Property I, L.P., Atlanta, GA (US)

(72) Inventors: Adrian Moore, Coppell, TX (US); Venson Shaw, Kirkland, WA (US)

(73) Assignee: AT&T Intellectual Property I, L.P., Atlanta, GA (US)

(21) Appl. No.: 19/208,653

(22) Filed: May 15, 2025

(51) Int. Cl. H04B 7/185; H04B 7/195; H04L 41/16; H04W 4/50; H04W 28/02

(52) U.S. Cl. CPC H04B 7/18586; H04B 7/195; H04L 41/16; H04W 4/50; H04W 28/0226; H04W 28/0236

(57) ABSTRACT

Aspects of the subject disclosure may include, for example, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. Other embodiments are disclosed.

### FIELD OF THE DISCLOSURE

The subject disclosure relates to apparatuses and methods for facilitating a dynamic radio access network with retrieval-augmented generation for satellite geo-location.

### BACKGROUND

Advancements in wireless communications have driven the evolution of mobile network infrastructure, supporting enhanced bandwidth, reduced latency, and improved overall performance. Networks extend across diverse settings, from densely populated urban centers to remote and rural areas, and the integration of terrestrial and non-terrestrial connectivity continues to grow in importance. Operators are increasingly looking to combine multiple access approaches to support a wide range of communication functions and to meet ever-evolving consumer demands. In parallel, there is significant interest in leveraging methodologies for enhancing network resource utilization across varied and dynamic operating conditions.

Service providers are driven by a need to extend high-speed, reliable communications to all areas, including those traditionally underserved due to cost constraints and physical obstacles. Existing solutions strive to ensure dynamic bandwidth allocation and flexible capacity management, yet they often encounter limitations when addressing fluctuating network conditions or in synchronizing diverse communication paths. Industry continues to seek techniques that enhance coordination between different segments of a network, ensuring that connectivity remains robust irrespective of geography or operational challenges.

Despite considerable progress in mobile network design, many conventional techniques struggle to meet the demands of dynamically changing environments. In many deployments, systems are constrained by static scheduling techniques and limited dynamic adaptation to real-time network conditions. Such limitations can lead to inefficient utilization of available capacity when traffic surges/spikes in demand occur, especially in scenarios where connectivity relies on both terrestrial and space-based platforms. As a result, there is a recognized need for more adaptive approaches that can intelligently manage network resources while mitigating inefficiencies associated with fixed or semi-static operational models.

In scenarios where satellite-based communication supplements terrestrial networks, precise coordination becomes essential to performance. Specific challenges arise regarding the timely identification of optimal connectivity windows when satellites are within effective range. This uncertainty can result in scheduling issues and redundant communication attempts that fail to exploit an available capacity.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for leveraging one or more models to facilitate a provisioning of communication services (inclusive of a transfer or conveyance of data or information) using resources or infrastructure of a terrestrial network, a non-terrestrial network, or a combination thereof. Other embodiments are described in the subject disclosure.

One or more aspects of the subject disclosure include, in whole or in part, obtaining first data pertaining to a load that is to be accommodated by terrestrial network infrastructure; analyzing the first data via a model; determining, based on the analyzing, that the load exceeds a threshold; identifying, based on the determining, at least one satellite that is available to support a portion of the load; selecting, based on the identifying, a satellite included in the at least one satellite, resulting in a selected satellite; establishing a connection with the selected satellite; and facilitating a transfer of second data over the connection to facilitate a communication service associated with the load.

One or more aspects of the subject disclosure include, in whole or in part, obtaining a user input, the user input including a natural language input; analyzing the user input in accordance with a long language model to determine that demand associated with communication services will exceed a capacity of communication resources available via a terrestrial network; based on the analyzing, selecting a satellite for facilitating a portion of the communication services in accordance with a satellite flight plan; and causing a conveyance of data between infrastructure of the terrestrial network and the satellite as part of provisioning the portion of the communication services.

One or more aspects of the subject disclosure include, in whole or in part, predicting, by a processing system including a processor, a likelihood of a user equipment executing an application associated with a communication service is greater than a threshold; determining, by the processing system and based on the predicting, that the communication service is a non-critical communication service; selecting, by the processing system and based on the determining, a satellite for provisioning at least a first portion of the communication service; and provisioning, by the processing system and based on the selecting, the first portion of the communication service via the satellite.

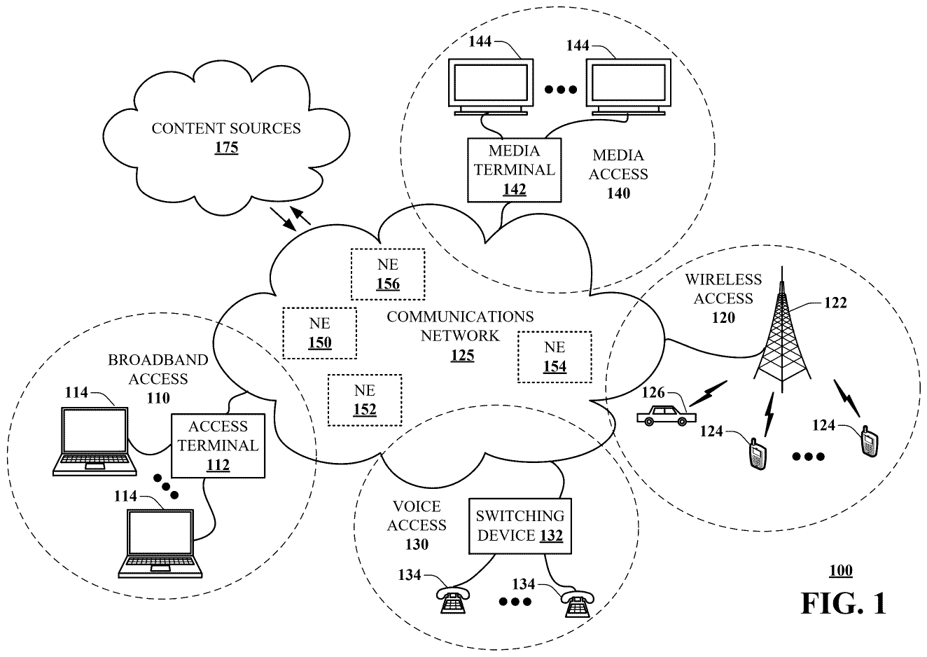

Referring now to FIG. 1, a block diagram is shown illustrating an example, non-limiting embodiment of a system 100 in accordance with various aspects described herein. For example, the system 100 can facilitate, in whole or in part, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. The system 100 can facilitate, in whole or in part, obtaining a user input, the user input including a natural language input, analyzing the user input in accordance with a long language model to determine that demand associated with communication services will exceed a capacity of communication resources available via a terrestrial network, based on the analyzing, selecting a satellite for facilitating a portion of the communication services in accordance with a satellite flight plan, and causing a conveyance of data between infrastructure of the terrestrial network and the satellite as part of provisioning the portion of the communication services. The system 100 can facilitate, in whole or in part, predicting, by a processing system including a processor, a likelihood of a user equipment executing an application associated with a communication service is greater than a threshold, determining, by the processing system and based on the predicting, that the communication service is a non-critical communication service, selecting, by the processing system and based on the determining, a satellite for provisioning at least a first portion of the communication service, and provisioning, by the processing system and based on the selecting, the first portion of the communication service via the satellite.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may facilitate an integration of one or more models (e.g., a long language model (LLM)) with retrieval-augmented generation (RAG) techniques to enhance (e.g., optimize) network configurations (e.g., 5G Non-Stand-Alone (NSA) configurations), including enhancements in/to communication between terrestrial 5G nodes and low earth orbit (LEO) satellites. This approach may supplement (or even replace) traditional performance indicators with a sophisticated LLM architecture trained on extensive datasets from user equipment (UEs), base stations (e.g., eNodeBs) and other infrastructure, and satellite communication patterns. The LLM may facilitate a dynamic machine-to-machine communication, using natural language to convey bandwidth deficits, apply satellite selection criteria, and configure communication channels or paths, thereby identifying the most suitable satellite for a 5G NSA configuration in. By leveraging satellite coordinates and flight plan databases, the described techniques may provide predictive recommendations on satellite selection and available bandwidth, reducing (e.g., minimizing) inaccuracies and enhancing (e.g., optimizing) network performance. This innovative use expands the capabilities of existing infrastructure, allowing for more efficient bandwidth augmentation and the potential for new use cases, such as user-prompted adjustments for scheduled events and enhanced customer/subscriber care applications.

Deployments of advanced networking technologies typically occur in phases or stages. For example, in terms of a rollout of 5G networking technologies, due to the costs involved, 5G tends to be deployed in more densely populated urban areas/regions. Rural/Remote applications tend to utilize 4G or 4G Non-Stand-Alone (NSA) configurations, given the broader geographic coverage supported by 4G.

In rural or remote areas, speed tier offerings are typically low or rely heavily on technologies like satellite or fixed wireless to handle traffic. Satellites in a NSA configuration enhance the bandwidth provided by terrestrial 5G towers. However, base/terrestrial antennas have limited time to communicate with satellites, posing challenges for latency-sensitive data communications such as voice, video, or point-of-sale applications. To address this, a GPS-like database with coordinates and travel paths for low earth orbit (LEO) satellites may be used. This enables an “intelligent” infrastructure to predict when a satellite will be within its communication profile/range (referred to hereinafter as a “viewing radius”), allowing traffic to be scheduled for delivery when additional bandwidth is available. In combination, a traffic scheduler may be included as part of a control plane, utilizing artificial intelligence (AI) or machine learning (ML) to perform historical predictive analysis and develop a satellite route and traffic map. This scheduler may allow the infrastructure to know when satellites will be visible and schedule traffic accordingly, reducing unnecessary communication with LEO satellites and reducing an associated noise floor.

Generative AI may be used in conjunction with a global satellite map to enhance predictive capabilities. The intelligent infrastructure may leverage this information to make predictions about satellite availability and schedule non-critical traffic accordingly. This approach may enhance, e.g., 5G NSA configurations by incorporating a LLM to improve communication and predictive analysis between terrestrial nodes and satellites. The LLM may facilitate machine-to-machine communication, enhancing infrastructure capabilities and supporting dynamic bandwidth expansion.

In accordance with aspects of this disclosure, an LLM may be utilized/invoked to determine when a deficit (e.g., a bandwidth deficit) has occurred in respect of a terrestrial network or resource. The LLM may use network selection criteria to identify which satellites within a viewing radius have the available capacity to support traffic being transported by the terrestrial infrastructure and satellite(s) in, e.g., a 5G NSA configuration.

An LLM architecture may be trained on extensive data from UEs, user-plane data, control-plane signaling, and satellite communication and flight patterns. This training may enable the LLM to generate human-like text patterns and make predictive recommendations on satellite selection and available bandwidth for transport. These LLMs will facilitate dynamic machine-to-machine communication and may be enhanced with retrieval augmented generation (RAG) techniques. This approach may leverage satellite coordinates and flight plan databases to provide domain expertise and prompt engineering, allowing the system to adapt to various use cases. The use cases may illustratively include or involve: user to 5G mobile, 5G and transported services, 5G and existing AI models, 5G and scheduled events where bandwidth is needed, and 5G and available spectrum.

In terms of the aforementioned use cases, user to 5G mobile may involve, utilize, or include a direct natural language or text interface into a Radio Access Network (RAN). By leveraging natural language from a user interface, an embedded LLM may enable users to manipulate the RAN and satellite infrastructure to augment capacity for immediate needs or schedule capacity for specific events. Additionally, the LLM can tailor the infrastructure to meet the specific needs of a user based on the amount and type of traffic being sent. In some embodiments, issues observed by a user may be supported (potentially as part of a report, a message, or the like), which can then be used to augment capacity or self-heal a network.

5G and transported services may facilitate an ability to leverage generative AI to marry specific satellite types to specific cell types that can be customized for specific traffic types for increased bandwidth or traffic prioritization. An LLM can utilize different frequency spectra based on specific applications, for instance, using a low-frequency band for larger geographical coverage or a higher frequency band for greater throughput. Applications can leverage the LLM to predict traffic needs for the services being transported or utilize user prompts to adjust the infrastructure to meet the demands of an event or specific application.

5G and existing AI models may feature a trained LLM that can be used to manage 5G and satellite infrastructure for 5G NSA configurations. This LLM can be integrated with existing AI models for applications like customer care, where the LLM can augment capacity in response to increasing care calls, among other exemplary instances/use cases.

5G and scheduled events may feature engineering prompts and natural language inputs that can be fed to a LLM to augment the 5G and satellite infrastructure, thereby increasing cell tower and satellite presence for scheduled events (e.g., concerts). For example, 5G and satellite infrastructure can be adjusted to meet the demands of the events. This approach leverages the powerful capabilities of LLMs and RAG techniques to dynamically manage and enhance (e.g., optimize) 5G and satellite networks, ensuring efficient and responsive infrastructure management.

5G and available spectrum may harness the capabilities of resources to dynamically provide for allocations to meet demands based on available resources and their respective capabilities. Intelligent decision-making processes of this disclosure may ensure that traffic is managed within a framework/profile of resources that are available, including licensed and unlicensed spectrum.

A LLM model may be trained using historical data from UE communication, user-plane, and control-plane interactions, as well as satellite coordinates and selection criteria. This comprehensive training will provide a holistic view of all communication paths used in, e.g., 5G NSA configurations between terrestrial and LEO satellite infrastructures. The LLM may be used to perform predictive analysis to identify traffic signatures that indicate bandwidth needs, historical success rates of satellite usage, and enhancement (e.g., optimization) strategies for specific traffic types based on time of day or specific events.

Integrating a LLM as part of a network/system architecture/platform may enable the LLM to support additional use cases that can be incorporated into existing and future AI models. By using engineering prompts, the LLM can dynamically trigger capacity adjustments, facilitating the enhancement (e.g., optimization) of various configurations, including 5G NSA configurations. The LLM may use historical UE and user-plane training data to predict user behavior, such as app usage and data types, and leverage UE positioning and location data to monitor UE concentrations and movements within a network.

In some embodiments, intelligent infrastructure within a near real-time radio intelligent controller (RIC) architecture for Open-RAN (ORAN) may use a trained LLM to gather information on the global footprint of LEO satellites. Databases containing global satellite information may interact with the LLM in a RAG configuration. This setup may use a vector database to ensure that satellites within a viewing radius with available capacity are utilized as part of a given networking configuration-e.g., a 5G NSA configuration. Given the specialized nature of satellite performance data, GPS coordinates, flight path data, and selection criteria, a RAG architecture may be employed to provide vectorized recommendations that will feed into the LLM, enhancing (e.g., optimizing) satellite selection and overall network performance.

In some embodiments, non-terrestrial infrastructure (such as, for example, a satellite) may be selected in accordance with criteria. To demonstrate, the criteria may include, or may be based on: connection availability, carrier to noise ratio, received signal strength, throughput, packet round trip delay, error rate, sector (cell) capacity, bandwidth capacity, and/or data link integrity and reliability.

The selection criteria may be used as an element of vectorized data fed into a LLM within the RAG architecture for satellite data. This information may be provided to the intelligent infrastructure, indicating when specific non-terrestrial infrastructure (e.g., satellites) will enter and leave a terrestrial antenna's viewing radius and which non-terrestrial infrastructure is/are best suited to address the needs (e.g., bandwidth deficit needs) of a communication device (e.g., a UE) at any given time and for specific traffic or application types.

Leveraging a RAG configuration for satellite data may aim to reduce inaccuracies from a LEO database interface. Prompt engineering may further ensure that the proper non-terrestrial infrastructure within a terrestrial antenna's viewing radius is utilized. This approach may be used to fine-tune an LLM model, enhancing model accuracy in facilitating satellite selection operations/techniques.

Outputs from a LLM may include natural language recommendations that may be provided to a traffic scheduler. These recommendations may help to facilitate determinations/identifications of whether noncritical traffic can be scheduled or queued for delivery based on an arrival of a satellite within an antenna's viewing radius, or if it is more advantageous to delay traffic until the arrival of a historically better-performing satellite. The arrangement may also enable/provide prompt insertion if additional information is required for traffic scheduling or if other use cases leverage the LLM outputs.

Data captured by a traffic scheduler may be used by a LLM to predict when bandwidth deficits are likely to occur, potentially based on historical information from terrestrial infrastructure (e.g., a base station). These predictions may be used to facilitate resource scheduling or allocation decisions, or analogously, traffic scheduling and management decisions.

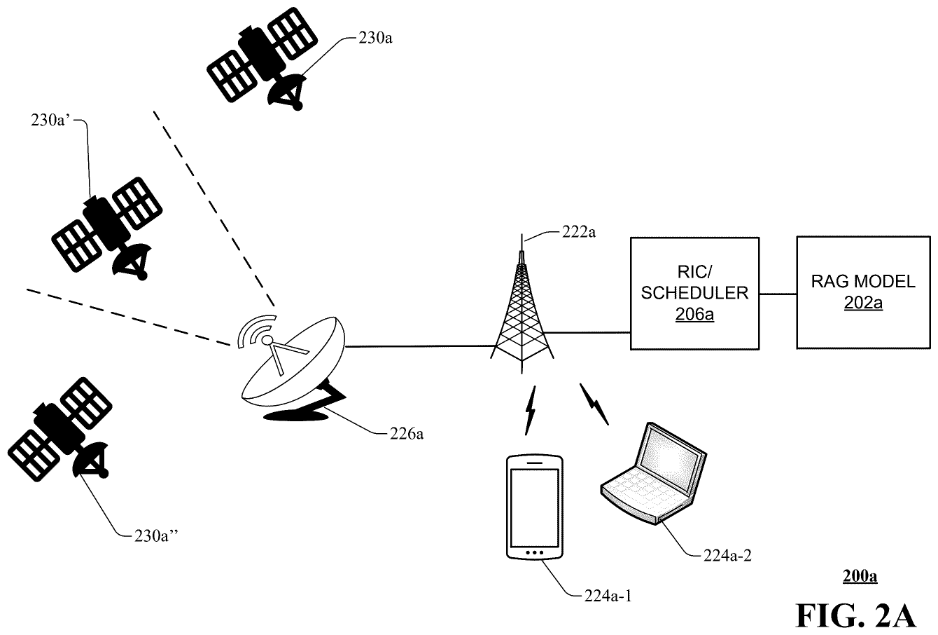

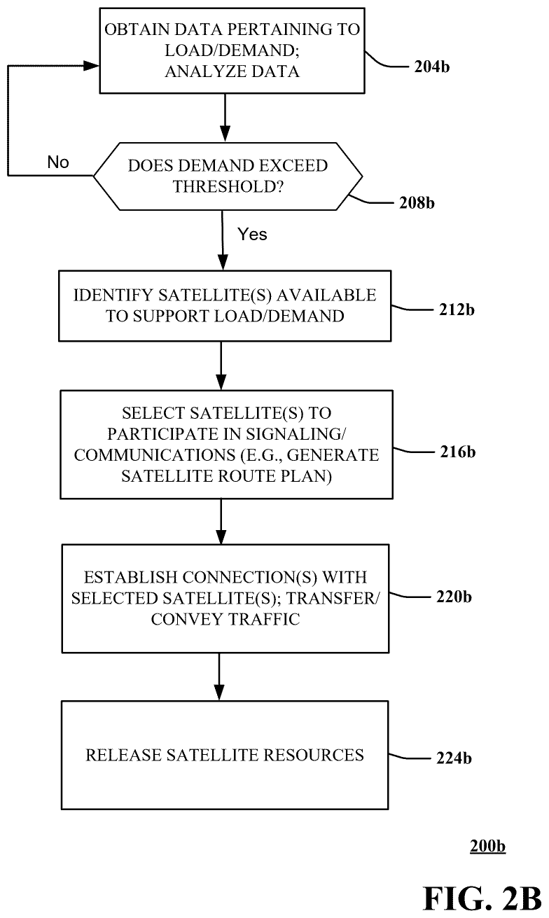

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1. Aspects of the system 200a may be implemented using hardware, software, firmware, or any combination thereof.

The system 200a may include a RAG model 202a, a RIC/scheduler 206a, a tower or base station 222a, one or more UEs (e.g., a first UE 224a-1 and a second UE 224a-2), a satellite dish/antenna 226a and a satellite depicted at three different times as represented by reference characters 230a, 230a′, and 230a″.

The RAG model 202a may include or support information/data pertaining to a number of satellites that may be supported by the system 200a (in this regard, it should be kept in mind that the satellite 230a/230a′/230a41 may be representative of one of a multitude of satellites that may be utilized/included). Information that may be stored as part of the RAG model 202a for a given satellite may include: a location of the satellite (as potentially specified in conjunction with one or more directions or coordinates), a direction of travel of the satellite, a speed of the satellite, a technology supported by the satellite, etc. Furthermore, for a given satellite dish/antenna (e.g., see antenna 226a), the information in the RAG model 202a may include an identification of when a given satellite will be within the viewing radius of the satellite dish/antenna. In this respect, it is noted that the satellite shown in FIG. 2A may be located within the viewing radius of the antenna 226a (wherein the viewing radius is represented by the space between the dashed lines emanating from the antenna 226a in FIG. 2A) at the time corresponding to reference character 230a′, and may be outside of the viewing radius at other times (including the times represented by reference characters 230a and 230″).

The information of the RAG model 202a may be used by the RIC/scheduler 206a to help facilitate data/traffic scheduling and management operations. For example, the data/information from the RAG model 202a may be used to augment/supplement information about load accommodated by the tower 222a, where such load may be representative of the traffic demands of UEs 224a-1 and 224a-2. In this regard, it should be kept in mind that the tower 222a may be tasked with supporting hundreds or even thousands of UEs at a given time (or over a given time period), such that the UEs 224a-1 and 224a-2 may be representative of just two of those UEs.

The RIC 206a may analyze the traffic demands/loads (both in terms of actual traffic demands/loads and predicted traffic demands/loads) to assess whether there is likely to be a deficit in resources available from the tower 222a to accommodate the demands/loads. If so, the RIC 206a may determine whether, based on the information available from the RAG model 202a, there is likely to be support available from one or more satellites to help offset the demands/loads. If so, resources of the satellite may be leveraged (such as, for example, in respect of a NSA configuration) to supplement the coverage being provided by the tower 222a. For example, as part of a 5G NSA configuration, 4G LTE technology supported by the tower/base station 222a may serve as a primary connection technology and resources associated with the satellite 230 a′ may function in the role of a 5G New Radio (NR) secondary connection technology. The resources of the satellite may be used to facilitate demands associated with non-critical traffic/load (or, analogously, a non-critical communication service), and may result in a queuing or deferral of a handling of such non-critical traffic/load (on, e.g., a best-efforts basis) until such a time as a satellite (see, e.g., satellite 230a′) being within a viewing radius of a (ground) antenna (see, e.g., antenna 226a). In some embodiments, an identification of traffic/load as non-critical (or, analogously, as critical) may be based on an identity/identification of an application that is executed by a communication device (e.g., a UE). In some embodiments, a sensitivity to latency may dictate whether traffic, load, or a communication service is deemed critical or non-critical; e.g., high-levels of sensitivity to latency may dictate a labeling as critical.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 204b, data may be obtained pertaining to load or demand. For example, the data may be indicative of a demand for communication services that are requested, or likely to be requested, by one or more communication devices (e.g., one or more UEs). The data may be analyzed as part of block 204b using one or more algorithms, models, technologies (e.g., AI or ML). The analysis of block 204b may include indications of a criticality (or, analogously, a non-criticality) of traffic included with the load/demand. For example, and all other conditions being assumed equal, support for voice communications may be considered critical (due to sensitivity to latency), whereas support for an email application might be considered non-critical (due to a general lack of sensitivity to latency).

In block 208b, a determination may be made whether, based on the analysis of block 204b, the load/demand exceeds a threshold. The threshold may be representative of a capacity of ground/terrestrial infrastructure to service the load/demand. If the determination is answered in the negative (meaning that the load/demand does not exceed the threshold), flow may proceed from block 208b to block 204b. Otherwise (meaning that the load/demand exceeds the threshold), flow may proceed from block 208b to block 212b.

In block 212b, one or more satellites that may be available to support the load/demand may be identified. For example, the identification of such satellites may be based on a satellite flight plan indicative of when satellites may be present within a viewing radius of a ground station antenna.

In block 216b, one or more satellites (of the satellite(s) identified as part of block 212b) may be selected to participate in signaling or communications with the ground station antenna. The selection(s) of block 216b may be based on identifications of load accommodated by the one or more satellites, capabilities of the one or more satellites, etc. The selections may be used to generate a satellite route plan that may be used to (tentatively) allocate traffic to the respective satellite(s).

In block 220b, connections may be established with the satellite(s) selected as part of block 216b. Based on establishing such connections, traffic (or, analogously, data) may be conveyed between the respective satellite(s) and terrestrial infrastructure (e.g., antenna, tower, base station) in block 220b. In turn, such traffic (or a processed version thereof) may be communicated to, e.g., a UE by way of the terrestrial infrastructure as part of block 220b.

Once the demand/need for a given satellite has lapsed, resources associated with the satellite may be released as part of block 224b. A release of resources in this context may include tearing-down or terminating a connection involving the satellite, which may serve to make the satellite available for other uses.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In some embodiments, a satellite route and traffic plan may be created/generated leveraging a traffic scheduler, a LLM and historical data/information via generative AI. For example, intelligent infrastructure, in conjunction with the traffic scheduler, may utilize a LLM and LEO satellite data provided through a RAG configuration. This arrangement may facilitate a predictive analysis to create/generate a satellite route and traffic plan, which may be based on a number of UEs/devices and the traffic demands and resources available at a specific terrestrial infrastructure. The LLM may be trained on historical data from a user plane, a UE (or set of UEs), and a control plane to forecast when bandwidth deficits are likely to occur, the traffic mix, and historical traffic demands observed by the user and control plane sides of a 5G NSA configuration to make scheduling determinations.

In some embodiments, intelligent infrastructure may interface with a LLM to acquire LEO satellite global coordinate mapping information, providing a comprehensive view of the global footprint of LEO satellites and their entry and exit times from a ground station or antenna's viewing radius. To reduce (e.g., minimize) inaccuracies, the intelligent infrastructure may interface with the LLM, and satellite data may be fed to the LLM via a RAG configuration/model, as potentially supplemented by engineering prompts, to ensure proper satellites within the ground station or antenna's viewing radius are utilized. This approach may fine-tune the LLM model for accurate satellite selection predictions.

An integration of historical traffic analysis at the intelligent infrastructure, combined with the LLM, RAG configuration, and engineering prompts, may enable the development and refinement of a satellite route and traffic plan. This plan may use natural language to specify when particular satellites will enter and leave the ground station or antenna's viewing radius. The LLM may predict traffic deficits and their likelihood based on historical data from the user plane, thereby enabling refinements/modifications in terms of predictions.

Equipping intelligent infrastructure with a tailored satellite route and traffic map, and leveraging vectorized data for a RAG implementation, may enable the infrastructure to target specific satellites that will be in a viewing radius at a specific time. This strategy, aligned with expected bandwidth demands identified by a LLM, may significantly reduce cross traffic and a noise floor across the LEO satellite constellation, promoting more reliable and efficient communications/signaling.

Aspects of this disclosure may be adopted across a network/system of terrestrial and non-terrestrial infrastructure. Aspects of this disclosure may enhance communication efficiency and may reduce the potential for intermittent communications/signaling.

Aspects of this disclosure may leverage generative AI to facilitate communication between a terrestrial infrastructure (e.g., base station) and LEO satellites, thereby providing for bandwidth augmentation. LLMs of this disclosure may enable machine-to-machine communication, providing for a degree of automation that has been lacking in the state of the art. These features may be used to expand upon an existing, universal non-terrestrial network database by integrating an LLM within the architecture. The LLM may act/function as an intelligent intermediary, replacing complex information exchanges with natural language to convey bandwidth deficits and apply satellite selection criteria to identify the most suitable satellite for configuration in a 5G NSA architecture. The LLM may be trained on extensive data from UEs, base stations, and satellites, enabling it to generate human-like text patterns and provide predictive recommendations on satellite selection and available bandwidth for transport. Enhanced with retrieval augmented generation (RAG) techniques, the LLM may leverage satellite data to ensure accurate and reliable communication. Using natural language also expands opportunities for user-prompted use cases, allowing generative AI to modify configurations within a 5G and satellite space.

In some embodiments, an LLM may be used to perform or provide predictive analysis or analytics to facilitate a determination or identification of traffic signatures that can be key markers to determine bandwidth needs, historical success rates when certain satellites are within a flight path and how they can be optimized, and traffic types that may be prevalent during a time of day or specific events where the communication paths can be augmented and optimized to meet the demand.

Aspects of this disclosure may leverage satellite route and coordinate information in a RAG configuration with a trained LLM to acquire information on a global footprint of LEO satellites. The RAG configuration may interface with the trained LLM using vectorized data that may be used to ensure when satellites are in the viewing radius of a ground station or antenna and have available capacity.

Aspects of this disclosure may facilitate a use of an LLM as part of machine-to-machine communications, potentially as part of a non-standalone (NSA) configuration. This approach allows for human-like communication between systems and devices, enabling the use of natural language to request additional bandwidth for specific needs, such as events involving a transfer or conveyance of data representative of, e.g., pictures or videos. The LLM may leverage predictive capabilities and global positioning databases to enhance communication, expanding use cases such as 5G transport services by predicting and augmenting capacity for specific traffic types at scheduled events. This technique decouples the need for specialized communication between machines, speeding up integration and allowing for more flexible data conveyances. Aspects of this disclosure may enhance predictive analysis capabilities and qualities/accuracies, leading to more rapid implementations with greater attendant accuracy and quality in service.

As one skilled in the art will appreciate based on a review of this disclosure, the various aspects of this disclosure are not directed to abstract ideas. To the contrary, the various aspects of this disclosure are directed to, and encompass, significantly more than any abstract idea standing alone. Indeed, the various aspects of this disclosure have been demonstrated herein to provide useful, concrete, and tangible results as part of numerous practical applications involving substantial improvements to technology. Such improvements may be quantified or qualified in terms of a reduction in signaling, a reduction in power consumption/dissipation, enhanced qualities and reliabilities in communications/signaling, etc. As such, the various aspects of this disclosure are transformative in nature and are representative of a major paradigm shift in provisioning communication services.

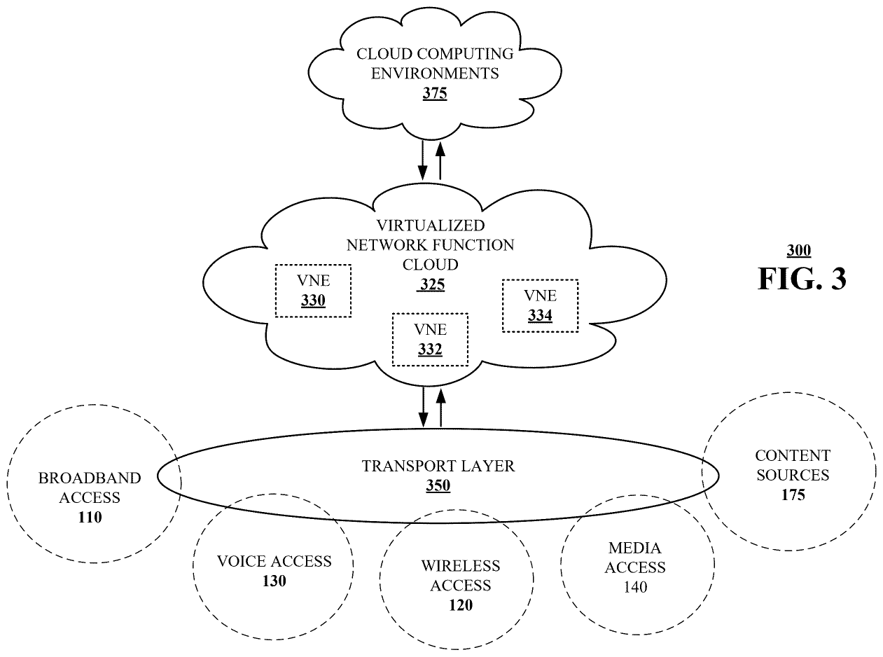

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, the virtualized communication network 300 can facilitate, in whole or in part, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. The virtualized communication network 300 can facilitate, in whole or in part, obtaining a user input, the user input including a natural language input, analyzing the user input in accordance with a long language model to determine that demand associated with communication services will exceed a capacity of communication resources available via a terrestrial network, based on the analyzing, selecting a satellite for facilitating a portion of the communication services in accordance with a satellite flight plan, and causing a conveyance of data between infrastructure of the terrestrial network and the satellite as part of provisioning the portion of the communication services. The virtualized communication network 300 can facilitate, in whole or in part, predicting, by a processing system including a processor, a likelihood of a user equipment executing an application associated with a communication service is greater than a threshold, determining, by the processing system and based on the predicting, that the communication service is a non-critical communication service, selecting, by the processing system and based on the determining, a satellite for provisioning at least a first portion of the communication service, and provisioning, by the processing system and based on the selecting, the first portion of the communication service via the satellite.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

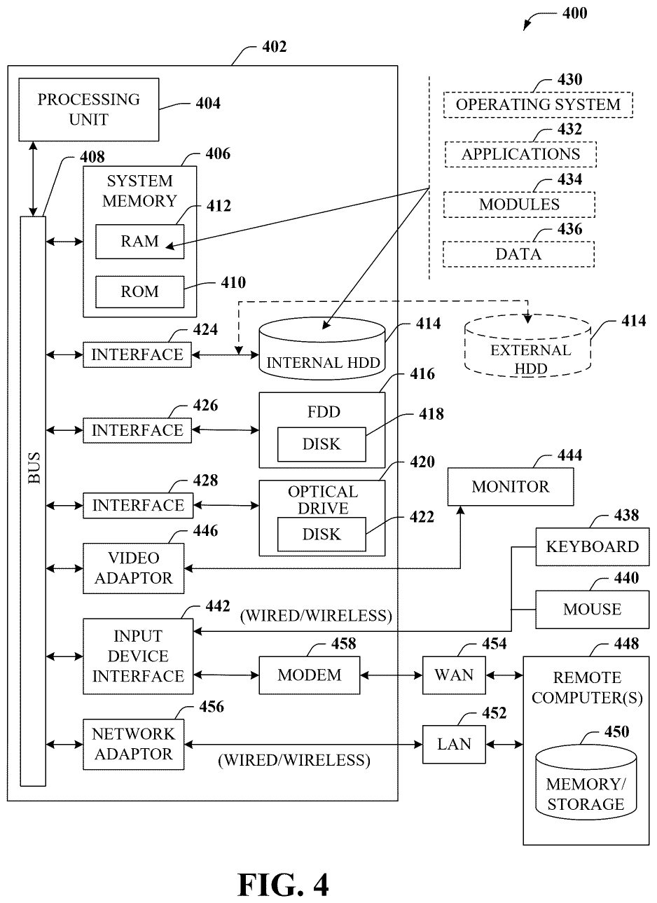

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. The computing environment 400 can facilitate, in whole or in part, obtaining a user input, the user input including a natural language input, analyzing the user input in accordance with a long language model to determine that demand associated with communication services will exceed a capacity of communication resources available via a terrestrial network, based on the analyzing, selecting a satellite for facilitating a portion of the communication services in accordance with a satellite flight plan, and causing a conveyance of data between infrastructure of the terrestrial network and the satellite as part of provisioning the portion of the communication services. The computing environment 400 can facilitate, in whole or in part, predicting, by a processing system including a processor, a likelihood of a user equipment executing an application associated with a communication service is greater than a threshold, determining, by the processing system and based on the predicting, that the communication service is a non-critical communication service, selecting, by the processing system and based on the determining, a satellite for provisioning at least a first portion of the communication service, and provisioning, by the processing system and based on the selecting, the first portion of the communication service via the satellite.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

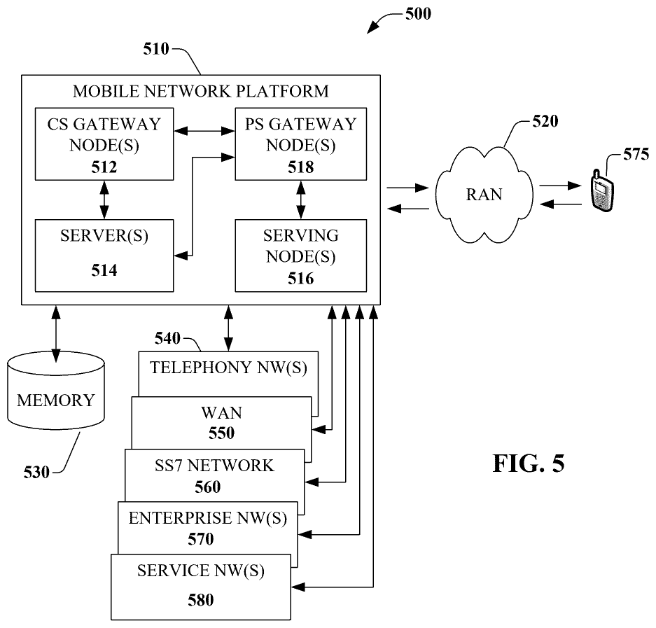

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. The platform 510 can facilitate, in whole or in part, obtaining a user input, the user input including a natural language input, analyzing the user input in accordance with a long language model to determine that demand associated with communication services will exceed a capacity of communication resources available via a terrestrial network, based on the analyzing, selecting a satellite for facilitating a portion of the communication services in accordance with a satellite flight plan, and causing a conveyance of data between infrastructure of the terrestrial network and the satellite as part of provisioning the portion of the communication services. The platform 510 can facilitate, in whole or in part, predicting, by a processing system including a processor, a likelihood of a user equipment executing an application associated with a communication service is greater than a threshold, determining, by the processing system and based on the predicting, that the communication service is a non-critical communication service, selecting, by the processing system and based on the determining, a satellite for provisioning at least a first portion of the communication service, and provisioning, by the processing system and based on the selecting, the first portion of the communication service via the satellite.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

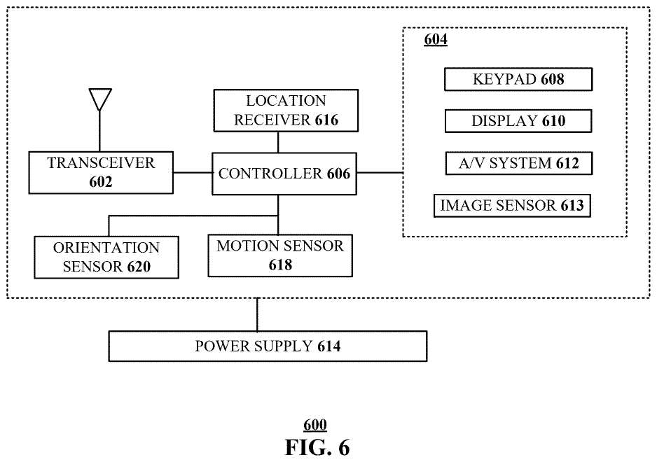

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining first data pertaining to a load that is to be accommodated by terrestrial network infrastructure, analyzing the first data via a model, determining, based on the analyzing, that the load exceeds a threshold, identifying, based on the determining, at least one satellite that is available to support a portion of the load, selecting, based on the identifying, a satellite included in the at least one satellite, resulting in a selected satellite, establishing a connection with the selected satellite, and facilitating a transfer of second data over the connection to facilitate a communication service associated with the load. The computing device 600 can facilitate, in whole or in part, obtaining a user input, the user input including a natural language input, analyzing the user input in accordance with a long language model to determine that demand associated with communication services will exceed a capacity of communication resources available via a terrestrial network, based on the analyzing, selecting a satellite for facilitating a portion of the communication services in accordance with a satellite flight plan, and causing a conveyance of data between infrastructure of the terrestrial network and the satellite as part of provisioning the portion of the communication services. The computing device 600 can facilitate, in whole or in part, predicting, by a processing system including a processor, a likelihood of a user equipment executing an application associated with a communication service is greater than a threshold, determining, by the processing system and based on the predicting, that the communication service is a non-critical communication service, selecting, by the processing system and based on the determining, a satellite for provisioning at least a first portion of the communication service, and provisioning, by the processing system and based on the selecting, the first portion of the communication service via the satellite.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first data pertaining to a load that is to be accommodated by terrestrial network infrastructure;
analyzing the first data via a model;
determining, based on the analyzing, that the load exceeds a threshold;
identifying, based on the determining, at least one satellite that is available to support a portion of the load;
selecting, based on the identifying, a satellite included in the at least one satellite, resulting in a selected satellite;
establishing a connection with the selected satellite; and
facilitating a transfer of second data over the connection to facilitate a communication service associated with the load.

2. The device of claim 1, wherein the operations further comprise:
processing the second data to generate third data; and
transmitting the third data to a user equipment as part of the communication service.

3. The device of claim 1, wherein the threshold is based on a capacity of the terrestrial network infrastructure.

4. The device of claim 1, wherein the at least one satellite includes a plurality of satellites.

5. The device of claim 4, wherein the selecting is further based on a respective capability of each satellite included in the plurality of satellites.

6. The device of claim 1, wherein the identifying is further based on a satellite flight plan associated with the at least one satellite.

7. The device of claim 6, wherein the identifying is further based on a viewing radius associated with a ground station antenna.

8. The device of claim 1, wherein the operations further comprise:
identifying the communication service as a non-critical communication service,
wherein the identifying of the at least one satellite that is available to support the portion of the load is further based on the identifying of the communication service as a non-critical communication service.

9. The device of claim 8, wherein the identifying of the communication service as a non-critical communication service is based on identifying a sensitivity of the communication service to latency.

10. The device of claim 8, wherein the identifying of the communication service as a non-critical communication service is based on an identity of an application that is being executed by a user equipment.

11. The device of claim 1, wherein the operations further comprise:
subsequent to the facilitating of the transfer of second data, determining that the load has been reduced relative to the threshold; and
based on the determining that the load has been reduced relative to the threshold, terminating the connection.

12. The device of claim 1, wherein the operations further comprise:
facilitating a transfer of third data to facilitate the communication service.

13. The device of claim 12, wherein the transfer of the second data and the transfer of the third data occur simultaneously.

14. The device of claim 13, wherein the transfer of the second data and the transfer of the third data occur as part of a non-standalone (NSA) configuration.

15. The device of claim 1, wherein the model includes a long language model (LLM).

16. A non-transitory machine-readable medium, comprising executable instructions that, when executed by a processing system including a processor, facilitate performance of operations, the operations comprising:
obtaining a user input, the user input including a natural language input;
analyzing the user input in accordance with a long language model to determine that demand associated with communication services will exceed a capacity of communication resources available via a terrestrial network;
based on the analyzing, selecting a satellite for facilitating a portion of the communication services in accordance with a satellite flight plan; and
causing a conveyance of data between infrastructure of the terrestrial network and the satellite as part of provisioning the portion of the communication services.

17. The non-transitory machine-readable medium of claim 16, wherein the operations further comprise:
configuring a communication path between the infrastructure of the terrestrial network and the satellite using the long language model to facilitate machine-to-machine communications in the conveyance of the data.

18. The non-transitory machine-readable medium of claim 16, wherein the satellite flight plan identifies a capability of the satellite and a time during which the satellite will be within a viewing radius of the infrastructure of the terrestrial network.

19. A method, comprising:
predicting, by a processing system including a processor, a likelihood of a user equipment executing an application associated with a communication service is greater than a threshold;
determining, by the processing system and based on the predicting, that the communication service is a non-critical communication service;
selecting, by the processing system and based on the determining, a satellite for provisioning at least a first portion of the communication service; and
provisioning, by the processing system and based on the selecting, the first portion of the communication service via the satellite.

20. The method of claim 19, further comprising:
provisioning, by the processing system, a second portion of the communication service via a terrestrial base station.
